(19) United States
(12) Patent Application Publication
(10) Pub. No.: US 2011/0242449 A1
(43) Pub. Date: Oct. 6, 2011

(54) LIQUID CRYSTAL DISPLAY DEVICE

(76) Inventor: Chao-Song Chang, Taipei City (TW)

(21) Appl. No.: 12/784,486

(22) Filed: May 20, 2010

(30) Foreign Application Priority Data
Mar. 31, 2010 (TW) 099205661

(51) Int. Cl. G02F 1/13357

(52) U.S. Cl. 349/61

(57) ABSTRACT

A liquid crystal display device includes a white light source, a liquid crystal display panel, and an electrochromic unit. The white light source has a light exiting plane, and the liquid crystal display panel is disposed on the light exiting plane of the white light source. Additionally, the electrochromic unit is disposed on the light exiting plane of the white light source, wherein the electrochromic unit displays different colors in sequence.

### BACKGROUND OF THE INVENTION

1. Field of the Invention

The present invention relates to a liquid crystal display device, and more particularly, to a liquid crystal display device, which uses a white light source and an electrochromic unit to implement color displaying by means of a color sequential method.

2. Description of the Prior Art

Color mixing methods in liquid crystal display devices can be divided into spatial color mixing methods and sequential color mixing methods. The spatial color mixing methods are widely utilized. Take a thin field transistor liquid crystal display (TFT-LCD) as an example. Each display pixel is composed of a red sub-pixel, a green sub-pixel, and a blue sub-pixel. The red sub-pixel, the green sub-pixel, and the blue sub-pixel respectively correspond to a red color filter, a green color filter, and a blue color filter. By the color mixing of the red sub-pixel, the green sub-pixel, and the blue sub-pixel of each display pixel, color displaying images can be recognized by the human visual system. The sequential color mixing methods do not require the color filter. By means of the color sequential method, the red light, the green light, and the blue light respectively pass through the liquid crystal display panel in sequence for the color mixing. Accordingly, the human visual system can recognize the effect of the color mixing by the photogene of the human eye. As a result, the color mixing method in time has following advantages. (1) Compared with the pixel in the conventional liquid crystal display device with the color filter is composed of a red sub-pixel, a green sub-pixel, and a blue sub-pixel, the pixel in the liquid crystal display device with the color sequential method can be reduced to improve the resolution of the liquid crystal display device, or to maintain the resolution of the liquid crystal display device with reduced cost of the thin film transistor substrate. (2) Without the color filter, the product cost of the liquid crystal display device can be reduced.

However, the color mixing of the liquid crystal display device by means of a color sequential method does not rely on the color filter, and the color mixing relies on the backlight composed of the red light, the green light, and the blue light. The light sources of the red light, the green light, and the blue light are generally light-emitting diodes. Accordingly, the area of each color is only one-third of the whole area rather than the whole area, and the color of the backlight may be non-uniform. Furthermore, the brightness of the liquid crystal display device by means of a color sequential method is only one-third of that in the liquid crystal display device completely using the white backlight. Additionally, the color presented by means of the color sequential method is mixed by the backlight with different colors, and external white light can not be directly utilized as the light source of the liquid crystal display device. As a result, the conventional color sequential method can only apply to transmissive liquid crystal display devices, but can not apply to reflective liquid crystal display devices or transflective liquid crystal display devices.

### SUMMARY OF THE INVENTION

It is therefore one of the objectives of the present invention to provide a liquid crystal display device to solve the problem and limitation in the prior art.

According to a preferred embodiment of the present invention, a liquid crystal display device is provided. The liquid crystal display device includes a white light source, a liquid crystal display panel, and an electrochromic unit. The white light source has a light exiting plane, and the liquid crystal display panel is disposed on the light exiting plane of the white light source. In addition, the electrochromic unit is disposed on the light exiting plane of the white light source, wherein the electrochromic unit displays different colors in sequence.

The liquid crystal display device of the present invention uses the white light source and the electrochromic unit to implement color displaying by means of the color sequential method. Compared with the prior art in which light-emitting diodes of three different colors are utilized for color mixing, the present invention uses white light source to enhance the brightness of each one of the colors to three times of that in the display device with the light source of three different colors. In addition, the present invention can be applied to transflective liquid crystal display devices to effectively utilize the ambient light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a liquid crystal display device according to a first preferred embodiment of the present invention.

FIG. 2 is a schematic diagram illustrating the first electrochromic film according to the first preferred embodiment of the present invention.

FIG. 3 is a schematic diagram illustrating a liquid crystal display device according to a second preferred embodiment of the present invention.

FIG. 4 is a schematic diagram illustrating a liquid crystal display device according to a third preferred embodiment of the present invention.

### DETAILED DESCRIPTION

In the following specifications and claims, certain terms are used throughout the description and following claims to refer to particular components. As one skilled in the art will appreciate, electronic equipment manufacturers may refer to a component by different names. This document does not intend to distinguish between components that differ in name but not function. In the following description and in the claims, the terms “include” and “comprise” are used in an open-ended fashion, and thus should be interpreted to mean “include, but not limited to”. To simplify the description and for the convenience of comparison between each of the embodiments of the present invention, identical components are denoted by identical numerals. It should be noted that the diagrams are for explanations and are not drawn as original sizes or to scale.

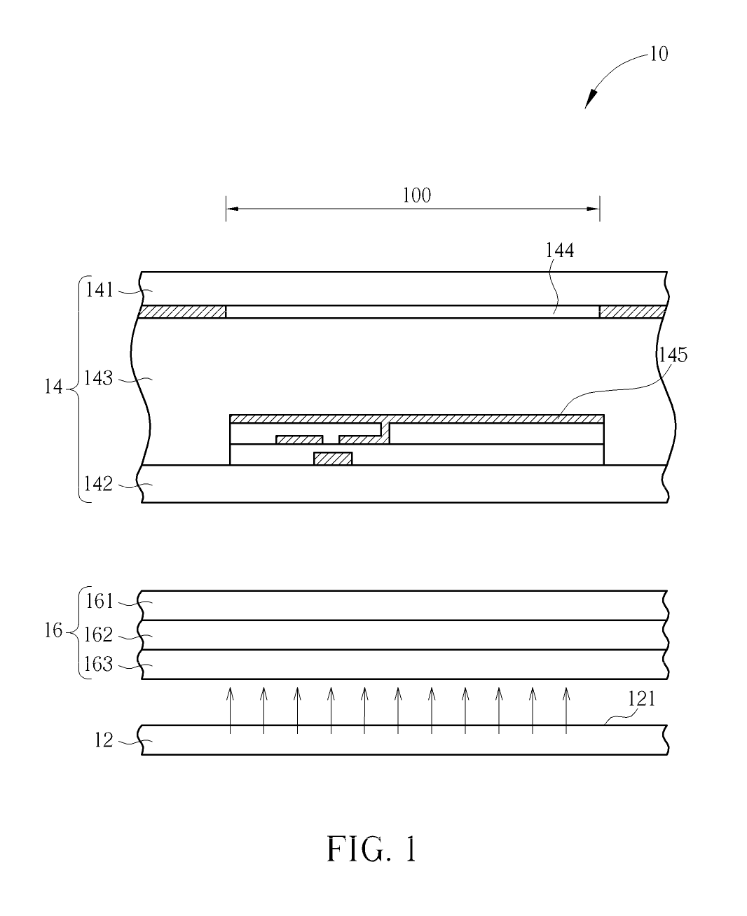

Please refer to FIG. 1. FIG. 1 is a schematic diagram illustrating a liquid crystal display device according to a first preferred embodiment of the present invention. As shown in FIG. 1, the liquid crystal display device 10 of the first preferred embodiment includes a white light source 12, a liquid crystal display panel 14, and an electrochromic unit 16. In the first preferred embodiment, the white light source 12 is a white light backlight module. For example, the white light backlight module may include a plurality of white light-emitting diodes (LEDs). But the white light backlight module is not limited herein and may include any other light source such as a cold cathode fluorescent lamp (CCFL). Also, the wavelength range of the white light source 12 may be substantially between 380 nm and 770 nm, so that the required light for the displaying of the liquid crystal display device 10 may be provided by the white light source 12. But the wavelength range is not limited herein and may be adjusted according to the product requirement. In addition, the white light (such as arrows shown in FIG. 1) is emitted from the light exiting plane 121, and some optical components (not shown in the figure) are disposed on the light exiting plane 121 to improve the brightness and uniformity of the white light source 12, such as a diffusion plate, a prism sheet, or a brightness enhanced film. Furthermore, the liquid crystal display panel 14 is disposed on the light exiting plane 121 of the white light source 12. As shown in FIG. 1, the liquid crystal display panel 14 includes a transparent substrate 141, an array substrate 142, and a liquid crystal layer 143. The array substrate 142 is disposed opposite to the transparent substrate 141, and the liquid crystal layer 143 is interposed between the array substrate 142 and the transparent substrate 141. Additionally, a plurality of pixel regions 100 are defined on the array substrate 142, and one pixel region 100 shown in FIG. 1 serves as an example for illustration. In the pixel region 100, a pixel electrode 145 is disposed on the array substrate 142, and a common electrode 144 is disposed on the transparent substrate 141. Also, in the pixel region 100, the liquid crystal layer 143 is interposed between the common electrode 144 and the pixel electrode 145. Accordingly, by adjusting the voltage difference between the common electrode 144 and the pixel electrode 145, the degree of light transmission may be controlled for displaying images with different patterns and gray scales. The liquid crystal display panel 14 of the present invention is not limited to the aforementioned embodiment, and the liquid crystal display panel 14 may be in any other suitable arrangement or may include other appropriate components. It should be noted that a conventional liquid crystal display panel usually includes a color filter, but the liquid crystal display panel 14 of the present invention with the electrochromic unit 16 does not require the color filter.

In addition, the electrochromic unit 16 is disposed on the light exiting plane 121 of the white light source 12. More specifically, in the first preferred embodiment, the electrochromic unit 16 is interposed between the liquid crystal display panel 14 and the white light source 12. Furthermore, the electrochromic unit 16 may display different colors in sequence. As shown in FIG. 1, the electrochromic unit 16 includes a first electrochromic film 161, a second electrochromic film 162, and a third electrochromic film 163. The first electrochromic film 161 may have a transparent state and a first color state. In the same way, the second electrochromic film 162 may have a transparent state and a second color state, and the third electrochromic film 143 may have a transparent state and a third color state. In the first preferred embodiment, the first color may be red, the second color may be green, and the third color may be blue. Accordingly, the electrochromic unit 16 may display red, green, and blue in sequence according to the principle of the color sequential method. For example, the first electrochromic film 161 of the electrochromic unit 16 is the first color (e.g. red in the present embodiment) state, and the second electrochromic film 162 and the third electrochromic film 163 of the electrochromic unit 16 are the transparent states. Under this condition, the first electrochromic film 161 may have the function of a red color filter, so that the white light passing through the first electrochromic film 161 becomes the red light. Then, the second electrochromic film 162 of the electrochromic unit 16 is adjusted to be the second color (e.g. green in the present embodiment) state, the first electrochromic film 161 of the electrochromic unit 16 is adjusted to be the transparent state, and the third electrochromic film 163 maintains the transparent state. Under this condition, the second electrochromic film 162 may have the function of a green color filter, so that the white light passing through the second electrochromic film 162 becomes the green light. Subsequently, the third electrochromic film 163 of the electrochromic unit 16 is adjusted to be the third color (e.g. blue in the present embodiment) state, the second electrochromic film 162 of the electrochromic unit 16 is adjusted to be the transparent state, and the first electrochromic film 161 maintains the transparent state. Under this condition, the third electrochromic film 163 may have the function of a blue color filter, so that the white light passing through the third electrochromic film 163 becomes the blue light. After that, the switching of the color repeats in this sequence. As a result, compared with the prior art in which light-emitting diodes of three different colors are utilized for color mixing, the present invention uses white light source to enhance the brightness of each one of the colors to three times of that in the display device with the light source of three different colors.

However, the electrochromic unit 16 of the present invention is not limited to the aforementioned embodiment. For example, the electrochromic film is not limited to the three-layered electrochromic film of the aforementioned embodiment, and the electrochromic film may be a single layer or multiple layers. Furthermore, the states of each electrochromic film are not limited to the single color state and the transparent state. In other words, the electrochromic unit 16 may have electrochromic films with multiple layers, or the electrochromic film may have the transparent state and color states with more than two colors according to the material characteristic of each electrochromic film. Therefore, more than three colors can be utilized for color mixing with the color sequential method in the present invention.

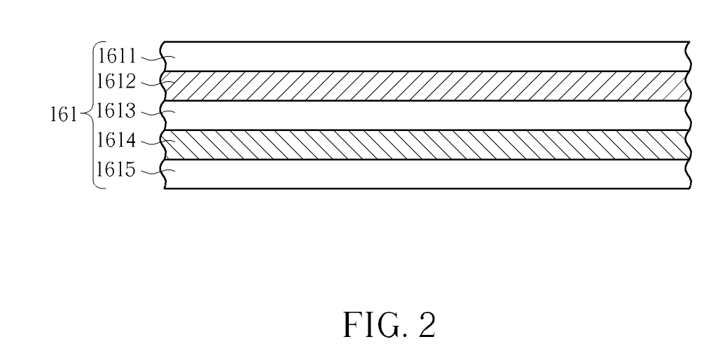

The structure and material of each electrochromic film of the electrochromic unit are illustrated as follows. Please refer to FIG. 2. FIG. 2 is a schematic diagram illustrating the first electrochromic film 161 according to the first preferred embodiment of the present invention. As shown in FIG. 2, the first electrochromic film 161 includes a first transparent conductive layer 1611, an electrochromic layer 1612, an electrolyte layer 1613, an auxiliary electrode layer 1614, and a second transparent conductive layer 1615. The electrochromic layer 1612 may have different colors under different voltage differences according to the oxidation-reduction modes of the material of the electrochromic layer 1612. The material of the electrolyte layer 1613 may be chosen from materials with high mobility, such as a hydrogen ion or a lithium ion. The auxiliary electrode layer 1614 may be an ion storage layer for storing ions which are utilized in the color changing process. The first transparent conductive layer 1611 and the second transparent conductive layer 1615 may be indium tin oxide (ITO) layers, but not limited herein. Also, the electrochromic material may be attached to the porous film (not shown in the figure) for increasing the surface area of the electrochromic material and improving the efficiency of the electrochromism. Similarly, the structure of the second electrochromic film 162 and the third electrochromic film 163 may be the same with the structure of the first electrochromic film 161. But it is not limited herein and may be adjusted according to different electrochromic materials. In addition, the electrochromic materials for displaying different colors in the present invention are described as follows and serve as an example. For the red color, the neutral state of PEDOP is red, and the oxidation state of PEDOP is bright blue, which is nearly transparent; the neutral state of N-propanesulfonate propylene dioxypyrrole (N—PrS ProDOP) is transparent, and other state by polymerization or controlling branched-chain functional groups may be red. For the green color, the neutral state of polyaniline is transparent, and the oxidation state of polyaniline is green. For the blue color, the oxidation state of WO₃, MoO₃, Nb₂O₅, PProDOT, or TiO₂ is transparent, and the neutral state of WO₃, MoO₃, Nb₂O₅, PProDOT, or TiO₂ is blue.

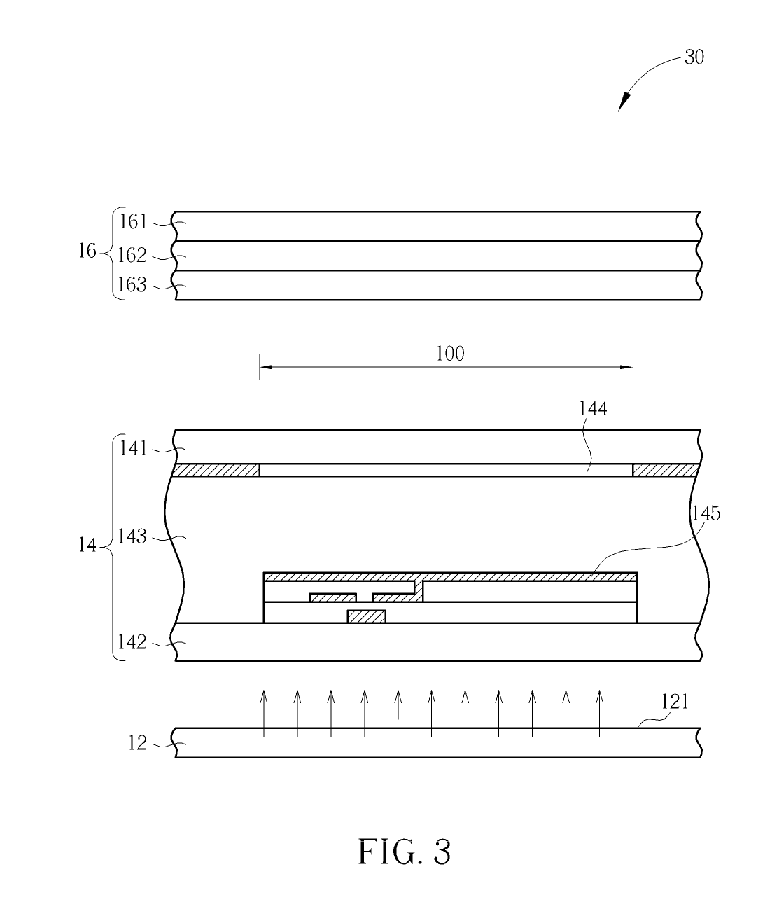

Please refer to FIG. 3. FIG. 3 is a schematic diagram illustrating a liquid crystal display device 30 according to a second preferred embodiment of the present invention. Because each component of the liquid crystal display device 30 of the second preferred embodiment of the present invention is substantially the same with that of the first preferred embodiment of the present invention, identical components are denoted by identical numerals and repeated descriptions are not redundantly given. As shown in FIG. 3, the difference between the second preferred embodiment and the first preferred embodiment is that the liquid crystal display panel 14 of the second preferred embodiment is interposed between the electrochromic unit 16 and the white light source 12. Accordingly, the light emitted from the white light source 12 may pass through the electrochromic unit 16. Also, as describe above, the red color, the green color, and the blue color may be displayed in sequence according to the principle of the color sequential method. Therefore, the liquid crystal display device 30 uses white light source to enhance the brightness of each one of the colors to three times of that in the display device with the light source of three different colors.

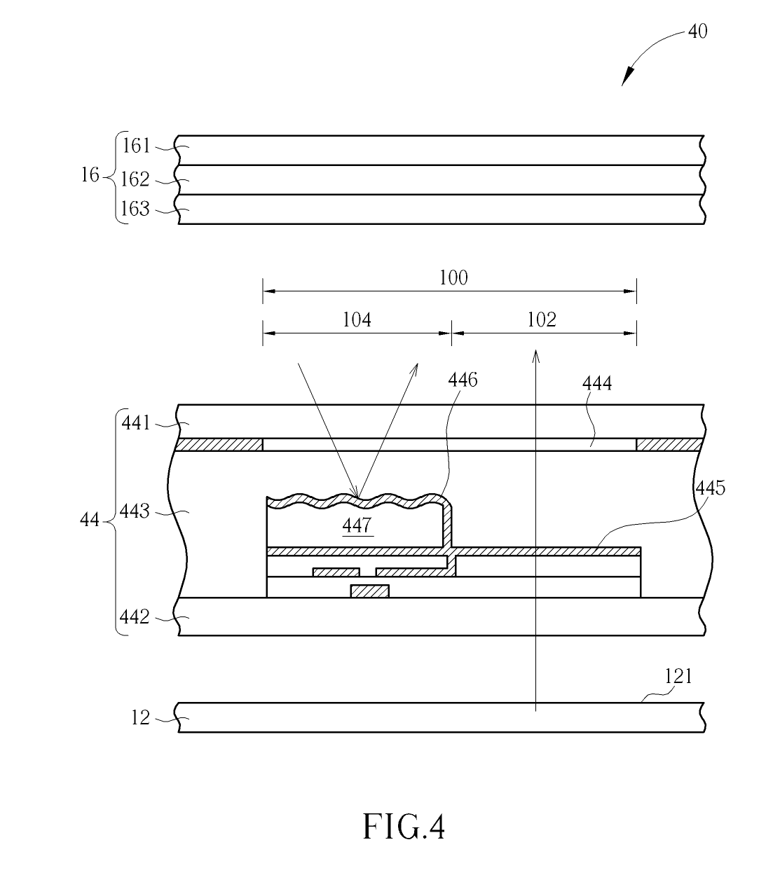

Furthermore, the present invention can be applied to transflective liquid crystal display devices. Please refer to FIG. 4. FIG. 4 is a schematic diagram illustrating a liquid crystal display device 40 according to a third preferred embodiment of the present invention. In the same way, components which are the same with that of the first preferred embodiment are denoted by identical numerals, and repeated descriptions are not redundantly given. As shown in FIG. 4, the liquid crystal display device 40 of the third preferred embodiment includes a white light source 12, a liquid crystal display panel 44, and an electrochromic unit 16. The liquid crystal display panel 44 includes a transparent substrate 441, an array substrate 442, and a liquid crystal layer 443. A plurality of pixel regions 100 are defined on the array substrate 442, and a transmission region 102 and a reflection region 104 are defined in each pixel region 100. Additionally, a pixel electrode 445 is disposed in the transmission region 102 of the pixel region 100, and a reflection electrode 446 is disposed in the reflection region 104 of the pixel region 100. Also, a common electrode 444 is disposed on the transparent substrate 441. Accordingly, the degree of light transmission of the liquid crystal layer 46 in the transmission region 102 and in the reflection region 104 can be controlled by the voltage difference between two sides of the liquid crystal layer 462, so that pictures with different patterns and gray scales can be displayed. A spacer layer 447 may be disposed under the reflection electrode 446 for adjusting the gap of the liquid crystal layer 462. By disposing the spacer layer 447, the gap of the liquid crystal layer 443 in the reflection region 104 is smaller than that in the transmission region 102. Therefore, the light passing through the transmission region 102 and the light passing through the reflection region 104 have the same phase difference.

As shown in FIG. 4, the liquid crystal display panel 44 is interposed between the electrochromic unit 16 and the white light source 12. When the ambient light is sufficient, the white light source 12 of the liquid crystal display device 40 of the present invention may be turned off, and the ambient light reflected in the reflection region 104 may serve as a light source for picture displaying. When the ambient light is insufficient, the white light source 12 of the liquid crystal display device 40 of the present invention may be turned on for picture displaying in the transmission region 102, and the reflected light of the ambient light may serve as a light source for picture displaying in the reflection region 104. It should be noted that both the light of the white light source 12 in the transmission region 102 and the reflected light in the reflection region 104 pass through the electrochromic unit 16. Therefore, as describe above, the light passing through the electrochromic unit 16 turns red, green, and blue in sequence according to the principle of the color sequential method. Accordingly, the liquid crystal display device 40 uses the white light source to enhance the brightness of each one of the colors to three times of that in the display device with the light source of three different colors, and the ambient light may be utilized for power saving.

In summary, the liquid crystal display device of the present invention uses the white light source and the electrochromic unit to implement color displaying by means of the color sequential method. Compared with the prior art in which light-emitting diodes of three different colors are utilized for color mixing, the present invention uses the white light source to enhance the brightness of each one of the colors to three times of that in the display device with the light source of three different colors. In addition, the present invention can be applied to transflective liquid crystal display devices to effectively utilize the ambient light for power saving.

Those skilled in the art will readily observe that numerous modifications and alterations of the device and method may be made while retaining the teachings of the invention.

What is claimed is:

1. A liquid crystal display device, comprising:
a white light source, having a light exiting plane;
a liquid crystal display panel disposed on the light exiting plane of the white light source; and
an electrochromic unit disposed on the light exiting plane of the white light source, wherein the electrochromic unit displays different colors in sequence.

2. The liquid crystal display device of claim 1, wherein the electrochromic unit comprises a first electrochromic film, and the first electrochromic film has a transparent state and a first color state.

3. The liquid crystal display device of claim 1, wherein the electrochromic unit comprises a second electrochromic film, and the second electrochromic film has a transparent state and a second color state.

4. The liquid crystal display device of claim 1, wherein the electrochromic unit comprises a third electrochromic film, and the third electrochromic film has a transparent state and a third color state.

5. The liquid crystal display device of claim 1, wherein the electrochromic unit is interposed between the liquid crystal display panel and the white light source.

6. The liquid crystal display device of claim 1, wherein the liquid crystal display panel is interposed between the electrochromic unit and the white light source.

7. The liquid crystal display device of claim 1, wherein the liquid crystal display panel comprises:
a transparent substrate;
an array substrate disposed opposite to the transparent substrate; and
a liquid crystal layer interposed between the transparent substrate and the array substrate.

8. The liquid crystal display device of claim 7, wherein the array substrate comprises a plurality of pixel regions, and each of the pixel regions has a transmission region and a reflection region.

9. The liquid crystal display device of claim 8, wherein the liquid crystal display panel comprises a pixel electrode disposed in the transmission region.

10. The liquid crystal display device of claim 8, wherein the liquid crystal display panel comprises a reflection electrode disposed in the reflection region.
